(19) United States
(12) Patent Application Publication
(10) Pub. No.: US 2013/0116908 A1
(43) Pub. Date: May 9, 2013

(54) METHOD AND SYSTEM FOR CONTROLLING RELATIVE POSITION BETWEEN VEHICLES USING A MOBILE BASE STATION

(71) Applicants: Young Chul OH, Hwaseong (KR); Yoon Ho JANG, Hwaseong (KR); Seong Su IM, Hwaseong (KR); Su Lyun SUNG, Hwaseong (KR)

(72) Inventors: Young Chul OH, Hwaseong (KR); Yoon Ho JANG, Hwaseong (KR); Seong Su IM, Hwaseong (KR); Su Lyun SUNG, Hwaseong (KR)

(73) Assignee: HYUNDAI MOTOR COMPANY, Seoul (KR)

(21) Appl. No.: 13/371,629

(22) Filed: Feb. 13, 2012

(30) Foreign Application Priority Data
Nov. 7, 2011 (KR) 10-2011-0115279

(51) Int. Cl. G05D 1/00

(52) U.S. Cl. 701/96

(57) ABSTRACT

A method and system of controlling a relative position between vehicles using a mobile base station is provided. GPS information is received from a satellite at a mobile base station and a target vehicle. The current position information the mobile base station is calculated with reference to a moving speed and direction based on the received GPS information. DGPS correction data is then generated by calculating the calculated position information and the received GPS information through a preset algorithm and the generated DGPS correction data is transmitted to one or more target vehicles. In the control target vehicle, the transmitted DGPS correction data is received, GPS information is received from a satellite, position information is calculated based on the received GPS information and the received DGPS correction data to execute position correction, and a speed and direction of the control target vehicle is adjusted according to the calculated position information.

### CROSS-REFERENCES TO RELATED APPLICATIONS

This application claims priority to Korean patent application No. 10-2011-0115279 filed on Nov. 7, 2011, the disclosure of which is hereby incorporated in its entirety by reference.

### BACKGROUND OF THE INVENTION

1. Field of the Invention

The present invention relates to technology for controlling a relative position between vehicles, and more particularly, to a method and system of controlling a relative position between vehicles using a mobile base station, which improves the accuracy of a relative position between vehicles and performs position control while communicating with a vehicle serving as a mobile base station of a differential global positioning system (DGPS) through vehicle to vehicle (V2X) communication.

2. Description of the Related Art

The Global Positioning System (GPS) is a space-based satellite navigation system that provides location and time information to remote devices located anywhere on or near the Earth. In order for most GPS devices to work properly, however, there typically must be an unobstructed line of sight to four or more GPS satellites. These systems are freely accessible by anyone with a GPS receiver.

Most GPSs have a typical kilometric error in positioning which ranges from about 5 to 15 meter and up to 30 m in some instances. Thus, the degree of accuracy for these systems is not as proficient as most automotive manufactures would like in order to provide a high degree of accuracy as to the vehicle's current location.

To supplement the known errors from the data received by the GPS satellite, a differential global positioning system real time kinematics (DGPS-RTKs) (hereinafter, referred to as ‘DGPSs’) has been widely used. DGPSs use a network of fixed, ground-based reference stations to broadcast the difference between the positions indicated by the satellite systems and the known fixed positions. These stations broadcast the difference between the measured satellite “pseudoranges” and actual (internally computed) “pseudoranges”. As a result receiver stations may use this information to correct their pseudoranges by the amount indicated.

Autonomous vehicle platooning in which multiple moving objects (mobiles) move together while maintaining a minimum safe distance apart has been developed to transfer large quantities of goods using multiple vehicles at all at once or allow multiple vehicles participating in events to move in straight rows. Anutonomous vehicle platooning improves fuel efficiency due to reduction in air resistance of the vehicle, reduces the risk of accidents, and improves convenience of a driver in each vehicle. However, since a complex technology for accurately controlling a relative position between vehicles using the DGPS, and the like is required, a significant cost is required to mount necessary sensors and equipment in each vehicle.

In some instances it is impossible to accurately find the exact position of a vehicle, a technology for improving relative position accuracy between vehicles is required. The DGPS, however, as noted above is limited by the location of the base station which is fixed. Thus, when a commercial DGPS correction data is used and a vehicle is located too far away from the base station, it is impossible to improve position accuracy even when the DGPS is used.

### SUMMARY OF THE INVENTION

Various aspects of the present invention have been made in view of the above problems, and provide a method and system of controlling a relative position between vehicles using a mobile base station, which improves the accuracy of a relative position between vehicles and performs position control while communicating with a vehicle serving as a mobile base station of a differential global positioning system (DGPS) through vehicle to vehicle (V2X) communication.

According to an aspect of the present invention, a system for controlling a relative position between vehicles using a mobile base station is provided. The system may include: a mobile bases station configured to transmit a DGPS correction data; and a control target vehicle configured to receive the DGPS correction data from the mobile base station and perform position control. The mobile base station may include: a first GPS reception unit configured to receive GPS information from a satellite; a position calculation unit configured to calculate current position information based on the received GPS information and a value detected by an internal sensor; a DGPS correction data generation unit configured to generate a DGPS correction data based on the calculated position information and the GPS information received from the first GPS reception unit; and a first V2X communication unit configured to transmit the DGPS correction data generated from the DGPS correction data generation unit to the control target vehicle. The control target vehicle may include: a second V2X communication unit configured to receive the DGPS correction data transmitted from the first V2X communication unit of the mobile base station; a second GPS reception unit configured to receive a GPS data from a satellite; a DGPS-based position information correction unit configured to calculate its own position information based on the DGPS correction data received from the second V2X communication unit and the GPS information received from the second GPS reception unit and perform position correction; and a traveling control unit configured to control a speed and direction of a vehicle based on the position information output from the DGPS-based position information correction unit.

The system may be implemented so that the mobile base station is set to a leading vehicle and at least one control target vehicle is disposed as a tacking vehicle for the leading vehicle.

The position calculation unit may include an inertial measurement unit (IMU) and an inertial navigation system (INS). The IMU may be configured to measure movement of the vehicle using a gyroscope and an accelerometer which measures rotational inertia based on free movement in a three dimensional space of a built-in pendulum and the earth's magnetic field which measures an azimuth as an axis. The INS may be configured to integrate an acceleration obtained from the gyroscope of IMU to obtain a speed and integrate the speed to obtain a position and an angle.

According to another aspect of the present invention, a method of controlling a relative position using a mobile base station in a vehicle position control system including a mobile base station configured to transmit a differential global positioning system (DGPS) correction data and a control target vehicle configured to receive the DGPS correction data from the mobile base station and execute position control. The method performed in the mobile base station may include: first receiving GPS information from a satellite; calculating current position information with reference to a moving speed and direction based on the received GPS information; calculating the calculated position information and the GPS information received from the first receiving the GPS information through a preset algorithm to generate a DGPS correction data; and transmitting the generated DGPS correction data. The method performed in the control target vehicle may include: receiving the DGPS correction data transmitted in the transmitting the DGPS correction data; second receiving GPS information from a satellite; calculating position information based on the second received GPS information and the received DGPS correction data to execute position correction; and controlling a speed and direction of the control target vehicle according to the position information calculated while calculating the position information.

The method may further include inputting a first reference point which is a standard of position conversion before first receiving the GPS information. More specifically, calculating the position information may include calculating an absolute position of the mobile base station based on the first reference point input.

The mobile base station may be set to a leading vehicle and at least one control target vehicle may be disposed as tracking vehicles for the leading vehicle so that the leading vehicle controls a relative position of the tacking vehicle.

Calculating the position information may include measuring movement of the mobile base station using a gyroscope and an accelerometer which measures rotational inertial based on free movement in a three dimensional space of a built-in pendulum and the earth's magnetic field which measures an azimuth as an axis.

Calculating the position information may include integrating an acceleration obtained from the gyroscope to obtain a speed and integrating the speed to a position and an angle.

According to the exemplary embodiment of the present invention having the above-described configuration, since a vehicle serving as a DGPS mobile base station is used, it is possible to recognize a relative position between vehicles as well as along all points on a moving route using a position calculation unit without having the limitations of a stationary DGPS service area and since an initialization value can be set directly in the position calculation unit, it is possible to provide a faster service than a general DGPS base station.

When vehicle platooning, since it is not necessary to mount separate sensors and equipment for tracking a leading vehicle, the illustrative embodiment of the present invention reduces cost and provides position service to autonomous groups of traveling vehicle as well as surrounding vehicles. That is, even when nonautonomous vehicle platooning based on the leading vehicle serving as a mobile base station is attempted, the illustrative embodiment may alternatively be employed to safely guide the direction and position of travel of that nonautonomous vehicle by recognizing a relative position to neighbouring vehicles based on the position information received from the DGPS mobile base station and controlling the traveling of the vehicle based on a recognized relative position.

The system and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a functional block diagram illustrating a system for controlling a relative position between vehicles using a mobile base station according to an exemplary embodiment of the present invention.

FIG. 2A is a view illustrating a process of generating and transmitting a difference global positioning system (DGPS) correction data in the leading vehicle serving as a mobile base station according to an exemplary embodiment of the present invention.

FIG. 2B is a view illustrating a process of performing position control in a tracking vehicle receiving a DGPS correction data according to an exemplary embodiment of the present invention.

FIG. 3 is a conceptual view illustrating a relative position control technology between vehicles using a mobile base station according to an exemplary embodiment of the present invention.

FIG. 4 is a view illustrating a process of correcting a relative position of a leading vehicle and a tracking vehicle to an arbitrary reference point according to an exemplary embodiment of the present invention.

### DETAILED DESCRIPTION

Reference will now be made in detail to various embodiments of the present invention(s), examples of which are illustrated in the accompanying drawings and described below. Like reference numerals in the drawings denote like elements. When it is determined that detailed description of a configuration or a function in the related disclosure interrupts understandings of embodiments in description of the embodiments of the invention, the detailed description will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

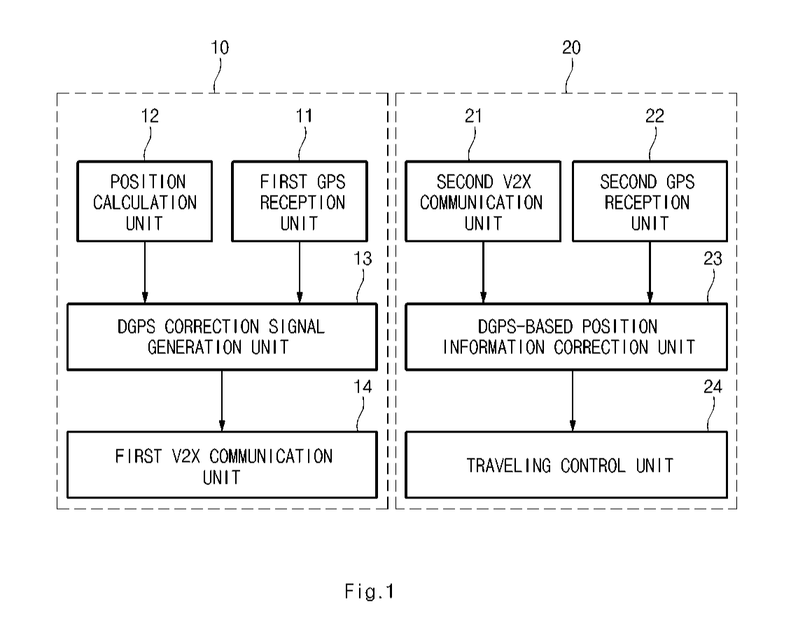

FIG. 1 is a functional block diagram illustrating a configuration of a system for controlling a relative position between vehicles using a mobile base station according to an exemplary embodiment of the present invention.

In FIG. 1 a leading vehicle 10 includes a controller configured to calculate a current position on the basis of global positioning system (GPS) data and serve as a mobile base station. A tracking vehicle is configured to receive a differential GPS (DGPS) correction data from the leading vehicle 10 through vehicle to vehicle (V2X) communication and execute position control.

The leading vehicle 10 includes a first GPS reception unit 11 configured to receive GPS information from a satellite and a position calculation unit 12 having an inertial measurement unit (IMU) and an inertial navigation system (INS) so that program instructions to calculate an absolute position information of a vehicle are mounted in the leading vehicle 10.

The leading vehicle 10 may further include a DGPS correction data generation unit 13 configured to correct DGPS correction data based on position information of a vehicle calculated by the position calculation unit 12 and the GPS information received by the first GPS reception unit 11. Additionally, a first V2X communication unit 14 is configured to transmit the DGPS correction data generated in the DGPS correction data generation unit 13 to another vehicle in a communication service area, that is, the tracking vehicle 20.

The tracking vehicle 20 includes a second V2X communication unit 21 configured to receive the DGPS control data transmitted from the first V2X communication unit 14 of the leading vehicle 10, a second GPS reception unit 22 configured to receive GPS information from a satellite, a DGPS-based position information correction unit 23 configured to calculate its own position information based on the DGPS correction data received from the second V2X communication unit 21 and the GPS information received from the second GPS reception unit 22 and perform position correction. Also, a traveling control unit 24 is configured to control a speed and direction of a vehicle based on the position information output from the DGPS-based position information correction unit 23.

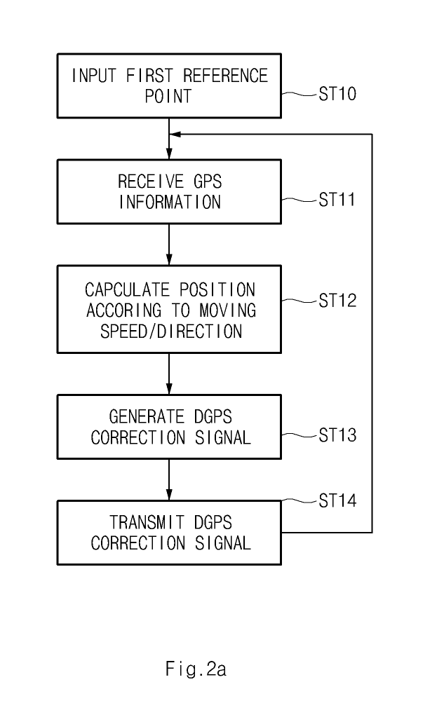

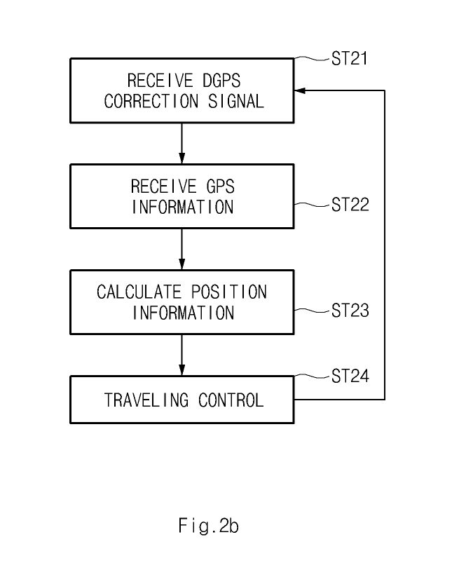

Next, an operation of the system having the configuration will be described with reference to sequence diagrams of FIGS. 2A and 2B.

FIG. 2A is a view illustrating a process of generating and transmitting a DGPS correction data in the leading vehicle 10 serving as a mobile base station and FIG. 2B is a position control operation in a tracking vehicle 20 receiving the DGPS data correction data.

First, as shown in FIG. 2A, when a driver inputs a first reference point which is a standard of position conversion in the leading vehicle 10 performing a function of a mobile base station (ST10), the DGPS correction data generation unit 13 receives GPS information from a satellite through the first GPS reception unit 11 (ST11), and the position calculation unit 12 calculates current position information with reference to a moving speed and direction of the vehicle, and the like based on the received GPS information (ST12).

The process of calculating the current position information in the position calculation unit 12 is performed by a method of measuring movement of a vehicle using a gyroscope and an accelerometer which can measure rotational inertia based on free movement in a three dimensional space of a built-in pendulum and the earth's magnetic field which can measure an azimuth as an axis through the IMU, and obtaining a speed by integrating an acceleration obtained from the gyroscope of the IMU and obtaining the position and direction by integrating the speed, through the INS.

The position information calculated in step ST12 inputs the DGPS correction data generation unit 13. The DGPS correction data generation unit 13 calculates the input position information and the GPS information received by the first GPS reception unit 11 through a preset algorithm to generate a DGPS correction data (ST13) and transmits the DGPS correction data to the first V2X communication unit 14 (ST14).

The DGPS correction data transmitted by the above-described process is received by the tracking vehicle 20 positioned within a communication service area. A process of processing the received DGPS correction data will be now described with reference to the sequence diagram of FIG. 2B.

As shown in FIG. 2B, when the DGPS correction data is received by the second V2X communication unit 21 (ST21), the DGPS-based position information correction unit 23 of the tracking vehicle 20 receives GPS information from a satellite through the second GPS reception unit 22 (ST22), calculates position information based on the received GPS information and the received DGPS correction data, and executes position correction (ST23).

Subsequently, the DGPS-based position information correction unit 23 controls the traveling control unit 24 according to the position information calculated by the above-described process to adjust a speed and direction of the tracking vehicle 20 (ST24).

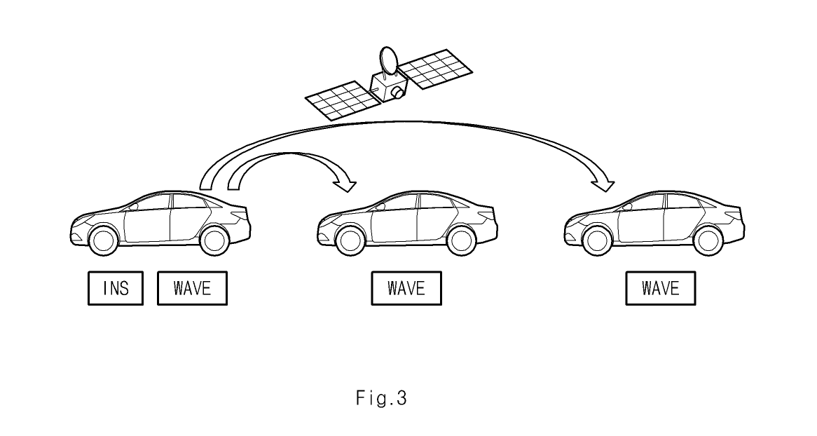

Therefore, as shown in FIG. 3, when multiple vehicles are platooning on the basis of the leading vehicle 10, the tracking vehicles can correct their own position information based on the DGPS correction data transmitted from the leading vehicle, recognizes a relative position relation, and accurately control the speed and direction, thereby performing vehicle platooning without the burden of large cost.

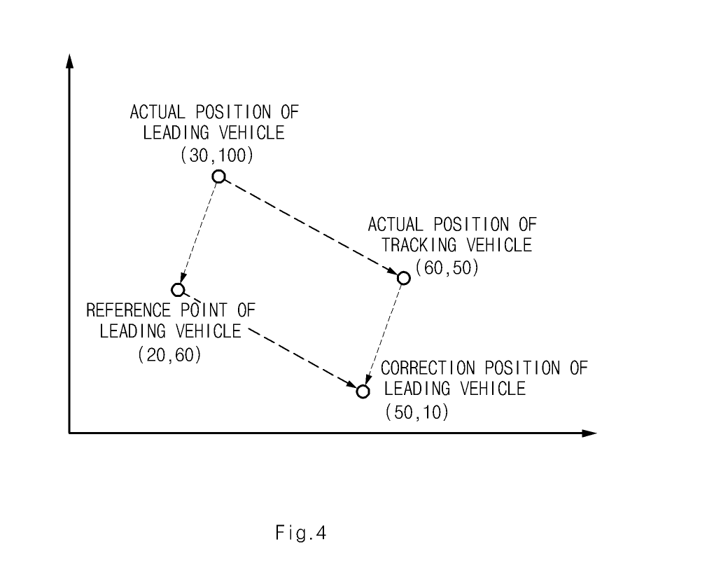

That is, according to the exemplary embodiment, it is possible to correct the position information using a vehicle performing a DGPS mobile base station function and thus it is possible to recognize a relative position between vehicles and a moving route using a position calculation unit without the limitations of a DGPS service area and directly set an initialization value in the position calculation unit. Therefore, as shown in FIG. 4, it is possible to correct a relative actual position difference between the leading vehicle and a tracking vehicle even with an arbitrary reference point and provide fast service in comparison to a general DGPS base station is used.

When vehicle platooning, it is possible to reduce cost and provide position service to autonomous platooning vehicles as well as surrounding vehicles without mounting additional sensors or equipment for tracking the leading vehicle in each vehicle.

The present invention is not limited to the exemplary embodiment. The above-described exemplary embodiment may be modified without departing from the spirit and scope of the present invention. The exemplary embodiment has illustrated autonomous vehicle platooning on the basis of a leading vehicle serving as a mobile base station, but it can be variously applied to service guiding a safety driving of a vehicle by recognizing a relative position to neighbouring vehicles based on position information received from a DGPS mobile bas station and controlling vehicle traveling based on the relative position.

In the above illustrative embodiment, the control unit may be embodied as a controller or processor configured to execute the above processes. Furthermore, the control logic within the controller or processor of the present invention may be embodied as non-transitory computer readable media on a computer readable medium containing executable program instructions executed by the processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for controlling a relative position between vehicles using a mobile base station, the system comprising:
a mobile bases station configured to transmit a differential global positioning system (DGPS) correction data,
the mobile base station including:
a first global positioning system (GPS) reception unit configured to receive GPS information from a satellite;
a position calculation unit configured to calculate current position information based on the received GPS information and a value detected by an internal sensor;
a DGPS correction data generation unit configured to generate a DGPS correction data based on the calculated position information and the GPS information received from the first GPS reception unit; and
a first V2X communication unit configured to transmit the DGPS correction data generated from the DGPS correction data generation unit to the control target vehicle; and
a control target vehicle configured to receive the DGPS correction data from the mobile base station and perform position control,
the control target vehicle including:
a second V2X communication unit configured to receive the DGPS correction data transmitted from the first V2X communication unit of the mobile base station;
a second GPS reception unit configured to receive GPS information from a satellite;
a DGPS-based position information correction unit configured to calculate its own position information based on the DGPS correction data received from the second V2X communication unit and the GPS information received from the second GPS reception unit and perform position correction; and
a traveling control unit configured to control a speed and direction of a vehicle based on the position information output from the DGPS-based position information correction unit.

2. The system of claim 1, wherein the mobile base station is set to a leading vehicle and at least one control target vehicle is disposed as a tacking vehicle for the leading vehicle.

3. The system of claim 1, wherein the position calculation unit includes an inertial measurement unit (IMU) and an inertial navigation system (INS).

4. The system of claim 3, wherein the IMU is configured to measure movement of the vehicle using a gyroscope and an accelerometer which measure rotational inertia based on free movement in a three dimensional space of a built-in pendulum and the earth's magnetic field which measures an azimuth as an axis.

5. The system of claim 4, wherein the INS is configured to integrate an acceleration obtained from the gyroscope of the IMU to obtain a speed and integrate the speed to obtain a position and an angle.

6. A method of controlling a relative position using a mobile base station in a vehicle position control system including a mobile base station configured to transmit a differential global positioning system (DGPS) correction data and a control target vehicle configured to receive the DGPS correction data from the mobile base station and execute position control, the method comprising:
receiving, at a mobile base station, global positioning system (GPS) information from a satellite;
calculating, at the mobile base station, current position information with reference to a moving speed and direction based on the received GPS information;
calculating, by the mobile base station, the calculated position information and the received GPS information through a preset algorithm to generate DGPS correction data;
transmitting, by the mobile base station, the generated DGPS correction data;
receiving, by a controller in the target vehicle, the DGPS correction data transmitted by the mobile base station;
receiving, by the controller in the target vehicle, GPS information from a satellite;
calculating, by the controller in the target vehicle, position information based on the GPS information received by the controller in the target vehicle, and the DGPS correction data to execute position correction; and
controlling, by the controller in the target vehicle, a speed and direction of the control target vehicle according to the position information calculated by the controller in the target vehicle.

7. The method of claim 6, further comprising inputting a first reference point which is a standard of position conversion before the first receiving the GPS information,
wherein the calculating the position information includes calculating an absolute position of the mobile base station based on the first reference point input in the inputting the first reference point.

8. The method of claim 6, wherein the mobile base station is set to a leading vehicle and at least one control target vehicle is disposed as tracking vehicles for the leading vehicle so that the leading vehicle controls a relative position of the tracking vehicle.

9. The method of claim 6, wherein calculating the position information includes measuring movement of the mobile base station using a gyroscope and an accelerometer which measure rotation inertial based on free movement in a three dimensional space of a built-in pendulum and the earth's magnetic field which measures an azimuth as an axis.

10. The method of claim 9, wherein calculating the position information includes integrating an acceleration obtained from the gyroscope to obtain a speed and integrating the speed to a position and an angle.

11. A non-transitory computer readable medium containing program instructions executed by a controller, the computer readable medium comprising:
program instructions that calculate current position information with reference to a moving speed and direction based on GPS information received at a mobile base station;
program instructions that calculate the calculated position information and GPS information received on the mobile base station through a preset algorithm to generate DGPS correction data; and
program instructions that transmit the generated DGPS correction data to a controller on a target vehicle.

12. A non-transitory computer readable medium containing program instructions executed by a controller, the computer readable medium comprising:
program instructions configured to calculate position information of a target vehicle in a vehicle platoon based on GPS information received from a satellite and DGPS correction data received from a mobile base station to execute position correction; and
program instructions that control a speed and direction of the target vehicle according to the position information.
